(19) United States
(12) Patent Application Publication
(10) Pub. No.: US 2012/0029980 A1
(43) Pub. Date: Feb. 2, 2012

(54) Method and Apparatus for Collecting Recyclable Materials

(76) Inventors: Shlomo Paz, Dacula, GA (US); Alan Pollak, Newtown, PA (US)

(21) Appl. No.: 12/845,188

(22) Filed: Jul. 28, 2010

(51) Int. Cl. G06Q 30/00; G06F 3/041; G06F 15/16; H04N 13/04; G06K 7/10; B07C 5/34

(52) U.S. Cl. 705/14.1; 709/217; 348/51; 345/173; 348/E13.075

(57) ABSTRACT

The invention provides an apparatus in which recyclable materials are collected, analyzed, crushed, sorted and stored; interactive media content is displayed and coupons are printed, wherein the content is selected based upon location, material collected, user information, user responses, and other variables; information about the user, user responses, materials received and other variables are stored in memory; and rewards for providing recyclable materials are given to the user in the form of points, coupons, and/or cash.

### FIELD OF THE INVENTION

The present invention relates generally to a method and apparatus for collecting recyclable materials, such as glass and plastic bottles, and aluminium cans.

### BACKGROUND OF THE INVENTION

Recycling is the process by which used but useful materials are processed into new products. Recyclable materials include many kinds of glass, paper, metal, plastic, textiles, and electronics. Recycling is a key component in waste reduction, and helps to save energy. For example, it requires far less energy to manufacture aluminum, glass and rubber from recycled raw materials than from new materials. Recycled materials may also have alternative uses. For example, glass may be used as construction aggregate, in brick manufacture, in water filtration, or as an abrasive.

Significant amounts of uncontaminated and well-sorted recyclable materials have the most post-consumer usefulness. For example, glass that is free of contaminants (such as lids, paper labels, stones, and metals), sorted by type (for example, light bulbs, window glass, and beverage bottles are not comingled), and then sorted by color (for example, separating clear, brown and green glass) can be put to valuable use, such as the manufacture of other glass containers or fiberglass. This uncontaminated, well-sorted glass has a relatively high resale value. In contrast, glass that is not sorted by color, or is highly contaminated, has a much lower resale value, and is used as aggregate material or is simply disposed of in landfills.

Many states provide a privately funded incentive for individuals to separate and recycle beverage containers in the form of container deposit laws. The laws typically apply to containers for beer, malt beverages, carbonated soft drinks, water, and/or wine coolers. These laws require the seller of canned or bottled beverages to collect a deposit on each container. This deposit is refunded to the customer upon the return of the container. In 2009, New York State reported that it had a redemption rate of 70%.

Superior sorting makes decontamination easier, and the quality of the sort is related to the how the material is collected. Common methods of collection include curbside recycling programs, collection centers, and reverse vending machines.

Curbside recycling programs are municipal programs typically offering weekly or bi-weekly collection of materials directly from households. Materials collected through curbside recycling programs are generally comingled (steel, glass, plastic and aluminum are collected in the same container and dumped into a truck) and are then sorted at a plant. This sorting method typically yields somewhat contaminated materials of relatively low usefulness and value.

Collection centers receive recyclables from consumers. Such centers cost less to operate than curbside recycling programs, and often have better sorting procedures, but of course involve more voluntary effort and compliance from consumers. Typically, residents must bring materials to a store or recycling center to obtain the deposit, which many consumers consider too troublesome for the payback. In addition, the stores or centers must crush, sort, and clean materials in order to sell them to recycling materials buyers. This method is far less convenient for the user than curbside programs.

Reverse vending machines may collect, process, and sort used beverage containers. Bottles and cans collected through reverse vending machines may have much less contamination since the machine is capable of separating the materials. Reverse vending machines are less rare than collection depots, and may not be centrally located. For example, reverse vending machines may be located at grocery stores, chain stores and redemption centers, but generally are not in malls, on school campuses, busy street corners, or places of leisure. Currently available reverse vending machines do not seem to have features that make them desirable or economically worthwhile to be centrally located.

A number of automated machines have been created and developed that sort, collect, and process used beverage containers. Current machines may also contain fraud prevention features, such as ways to prevent reimbursement for falsely-marked beverage containers. Also, rather than supply a machine with currency, they may issue receipts redeemable in the store where they are located. However, these machines still appear to have a number of significant shortcomings.

First, these systems require more compliance effort than curbside recycling programs. In other words, these systems require that the consumer travel, often out of the way, to a reverse vending machine, where they may redeem only a few dollars worth of containers. Aside from providing the user with return of the small container deposit fee, the machines do little to encourage use of recycling, or encourage the installation of reverse vending machines in centrally-located pedestrian areas.

Moreover, the primary incentive to make a trip to a reverse vending machine occurs when a large quantity of containers has accumulated. Even then, redeeming large quantities of used beverage containers is often a tedious and messy job. There is no real incentive, such as reward programs, sweepstakes or points systems, to make a separate trip to redeem a small number of containers, or to redeem containers from stats that do not offer redemption payments.

Third, current systems do not effectively use educational and marketing media. Current systems do not display or print targeted educational and marketing material to effectively educate and engage users. Interactive, direct response media is unavailable on current systems.

Fourth, information regarding the user, brand and quantity of various containers collected can serve as valuable marketing information if properly collected. Current reverse vending machines fail to collect and transmit this information to marketers via a convenient online system.

Finally, many reverse vending machines commonly comingle the different colors of collected glass, called “three-mix.” In order to use three-mix for high-value uses, it must be sorted by a machine or by hand.

All of these factors result in systems that have less value to the owners and users, and do less than would be desirable to encourage recycling and reuse of the containers in a cost effective manner. Accordingly, it would be desirable to provide a system and method that provides collection of recycled materials without encountering the limitations of the foregoing systems and methods, primarily by providing a system and apparatus that maximizes usefulness of collected materials, collects and transmits information about the user and materials collected, offers targeted, interactive marketing and educational media, and rewards recycling activity.

### SUMMARY OF THE INVENTION

The present invention addresses many of the shortcomings associated with the available systems. It is one object of the invention to maximize the usefulness of collected materials. In this regard, the invention provides a method and apparatus to analyze the shape and recognize the bar code of inserted containers. Once identified, the materials can be sorted not only by composition, for example, glass, aluminum, and plastic, but also by glass or plastic color, so that the creation of less valuable three-mix is avoided. Another object of the invention to maximize storage capacity. To this end, the invention provides a method and apparatus to crush the collected material, and deposit it in the appropriate container with other material of the same kind.

It is a further object of the invention to reward an individual for recycling any quantity of material, as well as materials that may not have a deposit value within the state. To this effect, the invention provides a method and apparatus to present the user reward programs in the form of cash, coupons, sweepstakes entries and points on a coupon, card, or otherwise stored with the user's information. The user's information, which can be stored on a card, local disk, local database or remote disk, can also maintain other data, such as the user's demographic information, recycling history, and value of cash deposits collected. The invention provides a method and apparatus to allow users to track, manage and/or share his or her information and recycling history.

It is an additional object of the invention to provide targeted media or advertising to the user. In this regard, the invention provides a method and apparatus to provide an educational or marketing message to the user based on the materials submitted, location, and/or the user's information. The media can be interactive. For example, the user can interact with the media with touch screen or other touch-capable device. Further, the invention provides a method and apparatus to print indicia, such as notices, coupons, tickets and the like, that may be related to user information, machine location, type of container deposited, the user's responses to the interactive or targeted media, or other information related to the machine, location, promotion, or interaction.

It is yet another object of the invention to engage businesses to participate in recycling. To this effect, the invention provides a method and apparatus to collect useful information, and allow media providers to track and manage media content and retrieve collected information via an online interface. The invention provides a method and apparatus to collect and transmit the previously-discussed information relating to the material collected, media displayed, media printed, user information, and responses to interactive media.

These and other objects are achieved and the disadvantages of prior systems overcome by the present invention. In one embodiment, the invention provides an apparatus for collecting and sorting recycled containers comprising a housing having an exterior and an interior, the exterior an opening for receiving a recyclable container; a dispenser mounted on the housing; a bar code reader mounted on the housing for determining container type; a reader for determining container type and/or color; a sorter for directing the container to one of a series of collecting bins; a crusher for crushing the container; a series of storage bins for storing containers sorted according to material and/or color; a receiver for receiving user responses; a dispenser for dispensing a payment form to an operator; a card or identification reader and associated updater for reading and updating a card or user information stored locally or remotely; a processor programmed to select and display media content from a memory containing such media in response to user; responses, user identity, container type, location, current media or educational promotion, or other predetermined variables; a display for displaying media content; a printer for printing indicia, such as notices, tickets, coupons and the like, with content chosen in response to user responses, user identity, container type, location, current media or educational promotion, or other predetermined variables; and memory for storing information about media displayed, user information, and materials collected.

The invention further provides a method for collecting recycled materials comprising: providing a recycling machine including a container receptacle having a bar code reader, means for identifying container material; a crusher and a storage bin; inserting a container into the container receptacle, analyzing the container to determine its type and material, crushing the container, depositing the container into a storage bin designed for matching container types; accumulating payment credit for deposited containers; providing a plurality of media choices; displaying media content selected in response to user responses, user identity, container type, location, or other predetermined variables; collecting user responses; recording user responses and the type of material received; and printing coupons with content chosen in response to user responses, user identity, container type, location, or other predetermined variables.

### BRIEF DESCRIPTION OF THE DRAWINGS

The features and advantages of the present invention can be more readily understood from the following detailed description of the preferred embodiments taken with reference to the accompanying drawings wherein:

FIG. 1 is a schematic drawing illustrating an improved recycling system according to one embodiment of the present invention;

FIG. 2 is a schematic drawing showing the interior of an improved recycling system according to an embodiment of the present invention; and

FIG. 3 is a flowchart demonstrating how media shown to a user is specifically targeted to the individual user, how user data is collected and transmitted, and how a user is rewarded for recycling.

### DETAILED DESCRIPTION OF THE PREFERRED EMBODIMENTS

The present invention addresses many of the shortcomings associated with available and proposed systems by providing a system to collect recyclable materials, enable a user to view and interact with targeted media content while recycling, reward the user for recycling, collect and transmit user information, allow aggregate user information to be viewed remotely, and maximize usefulness of collected materials. The present disclosure provides tools (in the form of methodologies, machines and systems) for collecting recyclable materials, and improving participation in recycling programs.

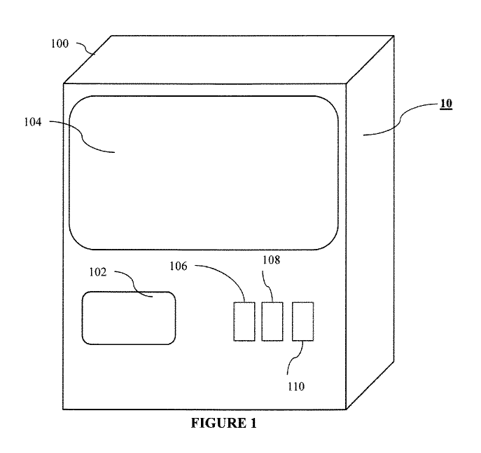

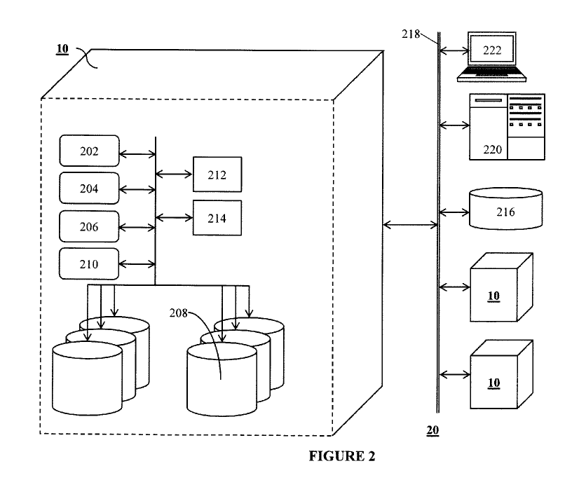

FIGS. 1 and 2 illustrate an embodiment of the recycling machine and system of the present invention generally designated with the reference numeral 10. FIG. 2 additionally illustrates an embodiment of the recycling machine and system of the present invention connected to a network and accessible by a computer terminal generally designated with the reference numeral 20. In accordance with the present invention, the recycling machine and system 10 includes a housing 100; a window or other opening for inserting the containers 102; a display 101, which can be a touch screen device or other touch or pressure sensitive device capable of displaying high definition media; and an optional currency processor 108 for storing and dispensing currency; and a printer 110 for printing media such as coupons or receipts. In addition, the invention includes a user identification receiver and processor 106 for receiving and reading user identification means, and updating user information. User identification means can include biometric information, or a magnetic card, proximity card, bar code, PIN code, smart card, memory card or similar identification key. User information can be stored on the user identification means, if appropriate, or on a local disk or database, or on a remote disk or database.

Inside the housing 100, the recycling system 10 also includes a bar code reader 202, an optical reader 204, a crusher 206 for crushing containers, a series of storage receptacles 208 for storing crushed containers according to material type; a sorter 210 for sorting the crushed containers into the appropriate storage receptacles 208, a microprocessor or computer 212, with associated memory 214. One or more reverse vending machines 10 can be connected to a network 218 also containing a database 216, computer terminal 220 and/or a web content server 222, or multiples thereof as desired for the particular application. The network 218 can be a local area network (LAN) or a wide area network (WAN).

The bar code reader 202 and optical reader 204 read the bar code of the container, and determine the type of container can, glass bottle (by color), plastic bottle (by color) provided. The optical reader 204 is especially useful where the bar code cannot be read to determine the type of container. The processing unit 212 selects which media to display and/or print, determines payment, and manages user responses. Media to be printed and displayed is selected based upon data provided by the identification receiver and processor 106, bar code reader 202, the optical reader 204, the location of the machine, user responses, or other variables. Payment for deposits and rewards for recycling made may be in the form of currency, store credit, points or a combination thereof. The credits, points, or currency value may be used or accumulated, or donated to a charity from a selection provided on the display, or selected using a touch keyboard that can appear on the screen.

Local memory 214 or a remote database 216 may be used to store media content and user information, such as media to be displayed or printed, number of times a media is displayed or printed, the user's identification data, history, any other interaction between the user and the system, information about collected materials, amount of currency remaining in the currency processor, capacity remaining in the storage receptacles and other data. This information may be accessed and/or changed using a computer terminal 220 and optionally, the web content server 222, or a laptop, iPad, or similar device may also be connected directly to the machine for service, to download content or data, and the like. The computer terminal 206 may comprise, for example, a mobile phone, smart phone, personal digital assistant, a laptop computer, a desktop computer, or some other device capable of accessing the network over a broadband connection, for example, with a modem, a T1 line, a satellite connection or the like. The machine can also relay information and alerts to the computer terminal 220, database 216 or web content server 222, such as, for example, when it needs to be serviced or emptied, or to transfer information stored locally.

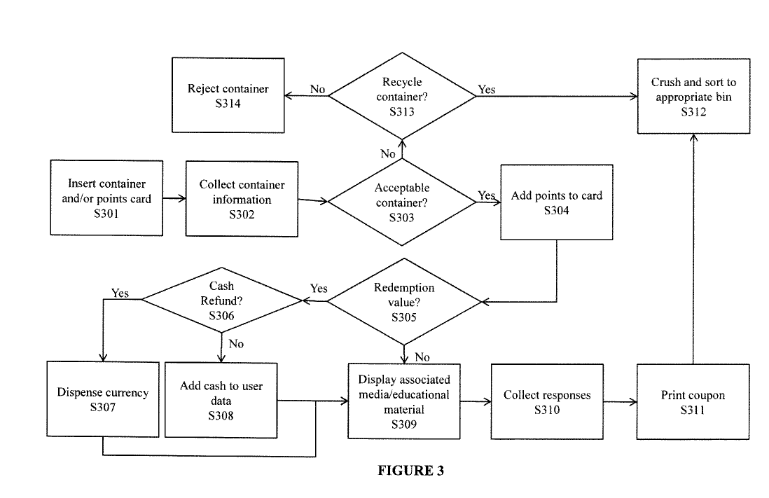

The recycling process as carried out by the present invention will be described with reference to FIGS. 1, 2 and 3. FIG. 3 is a flowchart demonstrating how media shown to a user is specifically targeted to the individual user, how user data is collected, and how a user is rewarded for recycling. A user supplies his or her identification to the identification receiver and processor 106 and a container into the machine 100 (Step S301). The bar code reader 202 reads the container's bar code, and the optical reader 204 and determines or confirms the container type (Step S302). If the container is acceptable (Yes, Step S303), the point value for the inserted container is added to the user's card, or stored in local or remote memory (Step S304) by the identification receiver and processor 106. The point value may also be printed onto a coupon. If the bottle is also redeemable for cash value (Yes, Step S305) and the user desires payment in cash (Yes. Step S306), the currency dispensing means 108 dispenses the correct amount of currency. If the bottle is redeemable for cash value (Yes, Step S305) and the user does not desire currency (No, Step S306), value may be added to the user's information by the identification receiver and processor 106, or dispensed according to other options discussed in more detail below (Step S308).

Based upon information provided by the container processor and, if appropriate, identification information, the processing unit selects which media to display (Step S309) to the display unit. Based upon the media displayed (Step S309), location, material type and, if appropriate, the collected responses (Step S310) the processing unit 201 selects media to be printed by the printer 104 (Step S311). The container is then crushed and forwarded to the appropriate bin 208 by the sorter 210 (Step S312). If the container is not one of the recognized items accepted by the machine 100 (No, Step S303), the machine can offer to accept the container for recycling without payment or credit (Yes, Step S313), and sort it according to material and color (Step S312). Otherwise, the machine 10 can reject it (No, Step S313).

The machine can also dispense coupons or literature either in response to one of the containers inserted or by direction of the database. For example, a coupon may be dispensed to go along with an advertisement, such as 10¢ off a six-pack of beer. Also, the machine can dispense coupon based upon the user's demographics, such as a sale coupon for a particular women's clothing store who sponsors advertisements. Likewise, the machine can dispense a coupon or show an advertisement on the viewing screen in response to correlation between particular beverage consumers and their likely purchasing habits. The machine might check the user's demographics before playing an advertisement or dispensing the coupon or product literature. Thus, after confirming, for example, that a man is operating the machine, the machine may display an advertisement for a new men's deodorant, or a sale at a nearby men's clothing store. Ads can also be displayed according to specified time and location purchases by advertisers, e.g., announcing new cleaning products in a machine-placed in a grocery store, or announcing a special sale item in a particular aisle of a drug, convenience or department store. Advertisements may also be viewable in three-dimensional (3D) format with or without the necessity for 3D glasses.

An important advantage of the present invention resides in its ability to donate the value of returned items to a charity. For example, as part of a school fund raising drive, the school encourages students to bring in containers to a machine located at the school or elsewhere nearby. The machine optionally allows the operator to donate the proceeds to the school whether or not the machine is on school premises. Further, a portion can be donated to the school itself, while other portions can be earmarked for school activities or organizations, or even another charity or function, the proceeds can be credited or saved to the operator's information for later use. If the reverse vending machine is located on a college campus, the bottle deposited is a soft drink container, and the user's information shows that the user has a history of depositing soft drink containers, the machine may offer a trailer advertisement for a newly released movie. The printer may print a coupon containing a discount for movie tickets or refreshments. It may also play certain ads regardless of the user, such as safe driving tips in a high school or college venue, or a reminder not to smoke or drink and drive.

As another example, a recyclable container from a state that does not collect bottle deposits may be inserted into the machine. Although no deposit can be given to the user, the user may be rewarded for recycling the container by receiving points or a coupon. Information about the container and user can be collected and stored with the user's information, such as on his or her card, or on the machine's local disk, or remote database.

Further, the machine can automatically update a user's social networking information to show a user's recycling activity, such as that the user recycled a certain amount of materials, and that the value of the returned items has been donated to a charity. The machine can also automatically enter users into sweepstakes or collection competitions on behalf of the user or a group to which the user belongs.

Data from a series of reverse vending machines can be collected, sorted, analyzed and presented in a useful format. For example, a drink manufacturer can ask for the operator to determine how many containers of a particular brand of beverage and/or type of container were collected by locality, user data, time period, etc., based upon zip code and time and date of deposit, for example. Similarly, an advertiser or other content provider can check progress or determine the success of a media, educational, or sweepstakes campaign. A charity group can check and share the progress of a fundraising campaign.

Numerous additional modifications and variations of the present disclosure are possible in view of the above teachings. It is therefore to be understood that within the scope of the appended claims, the present disclosure may be practiced other than as specifically described herein.

What is claimed is:

1. An apparatus for collecting and sorting recycled containers comprising:
a housing including an exterior slot for receiving recyclable containers; a dispenser for providing payment for received containers; a reader for reading and updating a user identification means and user info n; a display for displaying media content; means for collecting user responses; a printer for printing indicia with content chosen in response to user responses, user identity, container type, location, or other predetermined variables; the container receptacle having a bar code reader for reading the bar code of the container, means for identifying container type; a crusher for crushing received containers; a sorter for directing the container to one of a series of collecting receptacles; a series of storage receptacles for storing crushed containers sorted according to material and/or color; memory means for storing information about media, media displayed, user information, user interactions, materials collected, awards dispensed, or information about the operation of the apparatus; and a computer processor programmed to calculate payment for containers received and to select and display media content from the memory in response to user identity, user responses, container type, location or other predetermined variables.

2. The apparatus of claim 1, further comprising an external network, a remote database and a computer terminal, wherein the apparatus for collecting recycled containers, remote database, and computer terminal are connected to the network, and the user information, media or advertising, information about the media or advertising selected to be displayed or printed, information about materials collected and other information about the operation of the apparatus is stored on the database and is accessed and changed via the computer terminal or the computer processor.

3. The apparatus of claim 1, wherein the processor calculates payment in the form of points, cash, or cash equivalents, and payment is dispensed by the payment dispenser, printed to an indicia, or is added to the user's information.

4. The apparatus of claim 1, wherein the media content is displayed in high definition format.

5. The apparatus of claim 1, wherein the media content is viewable in three-dimensional format.

6. A method for collecting recycled materials comprising:
providing a recycling machine including a housing having an exterior slot for receiving recyclable containers, a dispenser for providing payment for received containers, a reader for reading and updating the user identification means and user information, means for collecting user responses, a display, a printer, a container receptacle having a bar code reader, means for identifying container type, a crusher, a series of storage receptacles, memory, and a computer processor,
beginning operation by accepting a container in the container receptacle, identifying the container using the barcode reader and means for identifying container material, crushing and depositing the container in one of the series of storage receptacles, each receptacle for storing a separate material and/or color, offering a selection of payment forms for the container, displaying media or advertising chosen in response to user information, user responses, container type, location, promotion, or other predetermined variables, recording user responses and the type of container received, dispensing payment, and printing indicia with content chosen in response to user responses, user identity, container type, location, promotion or other predetermined variables.

7. The method of claim 6, further comprising a network, a remote database and a computer terminal, wherein the recycling machine, remote database, and computer terminal are connected to the network, and the user information, media or advertising, information about the media or advertising selected to be displayed or printed, user responses, information about materials collected or other information related to the recycling machine is stored on the database and is accessed and changed via the computer terminal or the computer processor.

8. The method of claim 6, wherein the targeted media content is displayed in high definition format.

9. The method of claim 6, wherein the targeted media content is viewable in three-dimensional format.

10. The method of claim 6, wherein the means for collecting user responses comprises a touch-sensitive display.

11. The method of claim 6, wherein payment is in the form of cash or points, which is provided by the payment dispenser, printed on a coupon, or added to the user's information.

12. The method of claim 6, further comprising the operation of assembling, analyzing and presenting data collected from the machine in a useful format.
